(19) United States
(12) Patent Application Publication
(10) Pub. No.: US 2012/0002834 A1
(43) Pub. Date: Jan. 5, 2012

(54) Earbud Headset Positioning Device

(76) Inventor: Jaideep Singh Shahpuri, Cumming, GA (US)

(21) Appl. No.: 13/101,183

(22) Filed: May 5, 2011

Related U.S. Application Data
(60) Provisional application No. 61/361,520, filed on Jul. 5, 2010.

(51) Int. Cl. H04R 1/10

(52) U.S. Cl. 381/375

(57) ABSTRACT

A device which enables optimal positioning of both an earbud and microphone of an earbud headset. Two devices are used if the headset has two earbuds. The device can also be used with earbud headphone(s) (i.e. no microphone). The device comprises an anchor for positioning onto an ear of a wearer, and a cylindrical sleeve which is operatively connected to the anchor and able to attach to the end of an earbud headset. In an optional embodiment, the device comprises an earhook for positioning around a human ear, and a sleeve which is pivotally attached to the earhook and designed to hold the end of the earbud headset.

### CROSS-REFERENCE TO RELATED APPLICATIONS

This application claims priority to and the benefit of U.S. Provisional Application 61/361,520 filed Jul. 5, 2010, which is herein incorporated by reference in its entirety.

### FIELD OF THE INVENTION

The present disclosure is in the technical field ear positioning devices. More particularly, the present disclosure focuses on an earbud headset positioning device.

### BACKGROUND OF THE INVENTION

People use headphones or earphones to listen to audio from a large number of sources such as digital music players, tapes, cell phone, DVD players, radios, and the like. A headphone is well-known in the prior art as an electro-acoustic transducer that offers simplicity, personal audio, and portability. A headphone is typically used with a single ear, using a single audio channel, and in this singular configuration is generally suited more for spoken audio than music. A headphone can also be used in tandem with both ears, in which case the pair is referred to as headphones. Headphones are generally better suited for listening to music, particularly in stereo or where more than one audio channel is used. Headphone(s) are often worn by a wearer while simultaneously doing a variety of different activities. The physical activity level that a wearer can be engaged in while wearing headphone(s) can vary greatly, from stationary/sedentary all the way to highly vigorous extreme activities. Frequently, a significant range of physical activity levels may occur while listening to headphone(s) throughout a day or other time period. For example, a wearer may use headphone(s) while lying down, then later for running or other exercise, and later while studying.

### BRIEF SUMMARY OF THE INVENTION

The present disclosure describes a device (herein referred to as the device) which enables optimal positioning of both an earbud and microphone of an earbud headset. Two devices are used if the headset has two earbuds. The device can also be used with earbud headphone(s) (i.e. no microphone). The device for enabling the optimal positioning of both the earbud and microphone of an earbud headset comprise: an anchor for positioning onto an ear of a wearer; and a cylindrical sleeve which is operatively connected to the anchor and able to attach to the end of an earbud headset.

Note that the disclosed device is a distinct device for positioning an existing earbud headset. The device is not integrated within the earbud headset.

The anchor is sized to be easily positioned in the wearer's ear. The anchor can be perpendicular to the cylindrical sleeve or at an angle, for example 45 degrees. The anchor has a cylindrical portion which operatively connects to the cylindrical sleeve by being screwed into the sleeve. Since the anchor is screwed into the sleeve, the length of the anchor's cylindrical portion can be adjusted by rotating the anchor. Each rotation of the anchor adjusts the length of the anchor cylindrical portion by one screw thread. Enough friction exists between the cylindrical portion of the anchor and the cylindrical sleeve to prevent unintentional rotation or disconnection of the anchor. However, a wearer may use two hands to rotate the anchor and optimally adjust the length of the anchor's cylindrical portion.

The cylindrical sleeve is designed to attach onto an end of a headset, near the earbud. The cylindrical sleeve attaches to the outside of the end of the headset, with the sleeve sliding over the end. Enough friction exists between the cylindrical portion of the device and the end of the headset to prevent the two elements from being unintentionally disconnected. However, a wearer may use two hands to either combine or detach the cylindrical portion of the device and the end of the headset.

This disclosure also describes an alternate embodiment of the device which enables optimal positioning of both an earbud and microphone of an earbud headset. The separate embodiment of the device comprises: an earhook for positioning the device around a human ear; and a sleeve which is pivotally attached to the earhook and designed to hold an end of a headset.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows the elements of a human outer ear with the device inserted.

FIG. 2 shows an alternate embodiment of the device with an optional earhook.

FIG. 3 shows a perpendicular embodiment of the device.

FIG. 4 shows an angled embodiment of the device.

FIG. 5 shows a back view of an alternate embodiment of the device with an optional earhook.

FIG. 6 shows a bottom view of an alternate embodiment of the device with an optional earhook.

FIG. 7 shows a front view of an alternate embodiment of the device with an optional earhook.

FIG. 8 shows an isometric view of an alternate embodiment of the device with an optional earhook.

FIG. 9 shows a left view of an alternate embodiment of the device with an optional earhook.

FIG. 10 shows a right view of an alternate embodiment of the device with an optional earhook.

FIG. 11 shows a top view of an alternate embodiment of the device with an optional earhook.

FIG. 12 shows a back view of an angled embodiment of the device.

FIG. 13 shows a bottom view of an angled embodiment of the device.

FIG. 14 shows a front view of an angled embodiment of the device.

FIG. 15 shows an isometric view of an angled embodiment of the device.

FIG. 16 shows a left view of an angled embodiment of the device.

FIG. 17 shows a right view of an angled embodiment of the device.

FIG. 18 shows a top view of an angled embodiment of the device.

FIG. 19 shows a back view of a perpendicular embodiment of the device.

FIG. 20 shows a bottom view of a perpendicular embodiment of the device.

FIG. 21 shows a front view of a perpendicular embodiment of the device.

FIG. 22 shows an isometric view of a perpendicular embodiment of the device.

FIG. 23 shows a left view of a perpendicular embodiment of the device.

FIG. 24 shows a right view of a perpendicular embodiment of the device.

FIG. 25 shows a top view of a perpendicular embodiment of the device.

### DETAILED DESCRIPTION OF THE INVENTION

A variety of types/categories of headphone(s) designs have been developed over the years. One of the most popular is referred to as an earbud or earbud-type headphone. Earbud-type headphone(s) are also known as in-ear headphone(s), earbud speakerphone(s), or as canal phone(s). Earbuds are electro-acoustic transducer devices of a compact size designed to fit within the area of the concha and/or auditory canal of the external ear of a wearer so the wearer can listen to audio being transmitted from a sound source. Earbud(s) are an especially popular type of headphone(s) to be sold as a component of a packaged system, typically where the earbuds are sold along with a variety of different audio source devices. A particular phenomenon of this is the iPod® line of digital media players produced by Apple Computer Corporation of Cupertino, Calif. Over 100 million units of iPod media players and pairs of earbud-type headphones packaged therewith have been sold worldwide.

When properly positioned in the ear, earbud(s) can provide the wearer with acceptable sound transmission to the ear audio canal. However, due to anatomical variation between ears of different wearers, and to a lesser extent, ear-to-ear variation of a single wearer, earbud(s) may not fit a wearer's ear(s). Even a moderate increase in physical activity of a wearer will tend to worsen poor or marginal fit between an earbud and a wearer's ear. Additionally, movement during vigorous activity can cause even a well-fitting earbud to dislodge from the ear of a wearer, resulting in distraction and annoyance for the wearer.

Consumers tend to purchase earbud(s) without choice, given the frequency that they come packaged with an audio device. However, there are a wide variety of non-earbud type headphone(s) that can be purchased separately. Separately purchased headphone(s) may indeed fit a user better and can be more suitable for use during vigorous activities than earbud(s) that come with a wearer's audio device. One type of earphone(s) readily available is the ear-hook headphone that is so named from having a hook or hanger that rests behind the ear. Ear-hook headphone(s) are also known as around-the-ear headphone(s), over-the-ear headphone(s), or ear-hanger style headphone(s) and are generally considered a better choice during vigorous activity because of the more positive attachment to a wearer's ear when compared to earbud(s). There are many other headphone(s) options such as the type with a band that goes over the head of a user and having a speaker that fits within the concha or a larger speaker that is placed to or over the ear.

However, having to purchase a separate headphone(s) beyond the earbud(s) that are packaged with a particular audio device is generally undesirable. In addition, there may be times a wearer prefers a different styles of headphone(s). For example, a wearer may have a preference for an earbud type headphone(s) when studying yet prefer an ear-hook style headphone(s) when exercising. Furthermore, a separately purchased earphone may not have sound fidelity and/or quality as good as the earbuds that were specifically engineered and designed to go with a particular audio source. Finally, separately purchased earphone(s) are less likely to match the color and or style of the audio source device than are the original earbud(s) that can be designed to be a specific part of a coordinated audio system.

U.S. Patent Publication 2008/0310666 A1 (Wengreen) describes an earhook device that improves the fit of an earbud, makes it compatible with a greater range of anatomical variation, and improves the attachment of the earbud to a wearer's ear. Coincidentally, this makes the earbud more suitable for use during vigorous activity. The earhook device can be freely attached to the earbud and removed from the earbud. Limitations of the Wengreen device include that it is not adjustable, nor is it resize-able to fit different sized ears. U.S. Patent Publication 2008/0310666 A1 (Wengreen) is hereby incorporated by reference thereto in its entirety.

A headset is headphone(s) combined with a microphone. Correspondingly, an earbud headset combines earbud(s) with a microphone. The earbud headset enables two-way verbal communication between the wearer and someone else. An earbud headset typically has a set distance between the earbud(s) and the microphone. The distance is optimally set to easily enable speaking into the microphone as well as listening with the earbud(s). If the earbud headset is attached to a device as described in U.S. Patent Publication 2008/0310666 A1 (Wengreen), the microphone is no longer optimally positioned for speaking Hence for an earbud headset, a device is needed which enables both the optimal positioning of the earbud and the microphone.

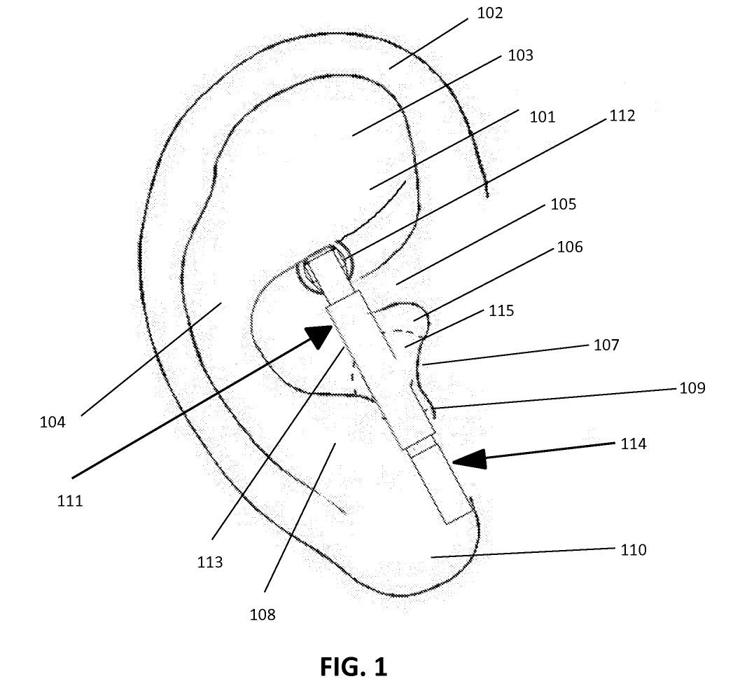

FIG. 1 shows the elements of a human outer ear with the device inserted. The elements shown to comprise a human outer ear 100 are a triangular fossa 101, helix 102, scaphoid fossa 103, anti-helix 104, concha 105, acoustic meatus 106, tragus 107, anti-tragus 108, intertragic notch 109, and lobule 110. The device 111 is shown with the anchor 112 being inserted underneath the triangular fossa 101. The anchor 112 is operatively connected to the cylindrical sleeve 113, being screwed into the sleeve. The cylindrical sleeve 113 is operatively connected to the end of a headset 114. The end of the headset 114 is also where an earbud 115 is located.

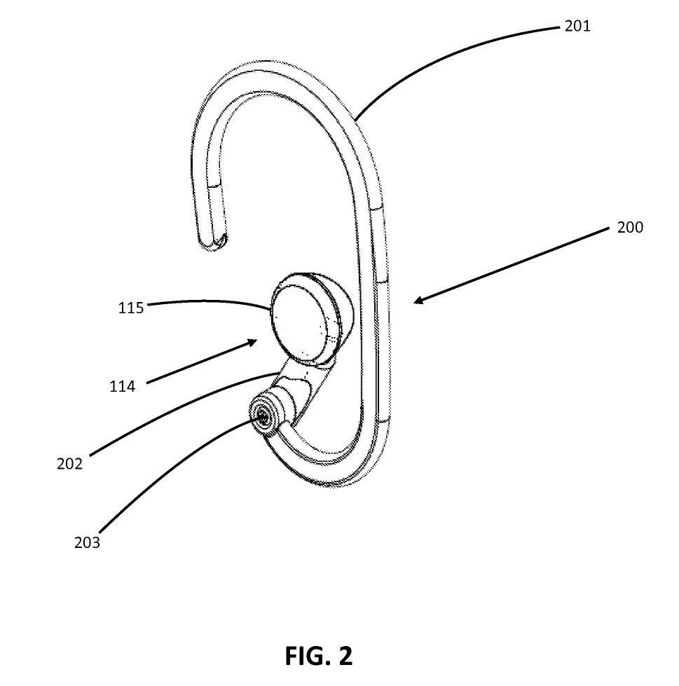

FIG. 2 shows an alternate embodiment of the device with an earhook. The alternate embodiment of the device 200 has an earhook 201 which is pivotally connected to a sleeve 202 with a fastener 203, allowing the sleeve 202 to rotate about one axis. The fastener 203 used for the pivotal connection can be a screw or rivet. The fastener 203 material of construction can be metal, plastic, or the like. The end of a headset 114 is operatively connected to the sleeve by being inserted into the sleeve 202. Enough friction exists between the sleeve 202 and the end of the headset 114 to prevent the two elements from being unintentionally disconnected.

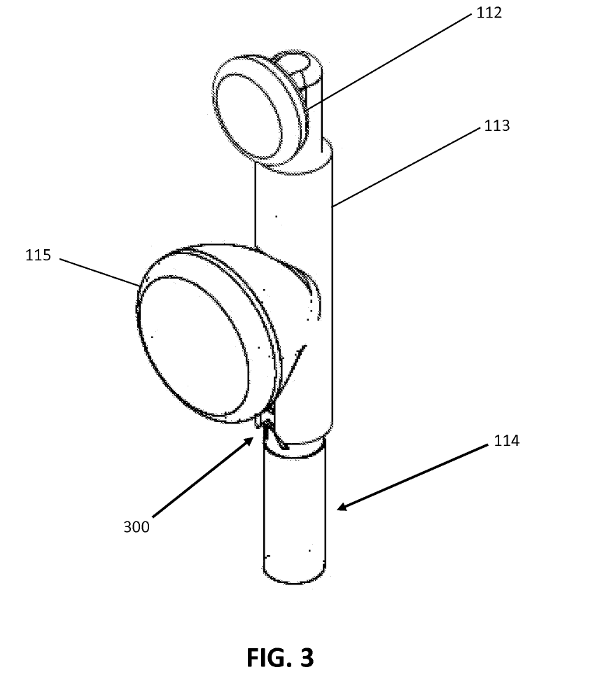

FIG. 3 shows a perpendicular embodiment of the device. In this embodiment, the anchor 112 is operationally attached, screwed into, and perpendicular to the cylindrical sleeve 113. The cylindrical sleeve 113 is operationally attached to the end of a headset 114 with an earbud 115. The cylindrical sleeve 113 contains a notch 300 which enables the cylindrical sleeve 113 to slide further down the end of the headset 114, creating more friction and a better connection between the cylindrical sleeve 113 and the end of the headset 114.

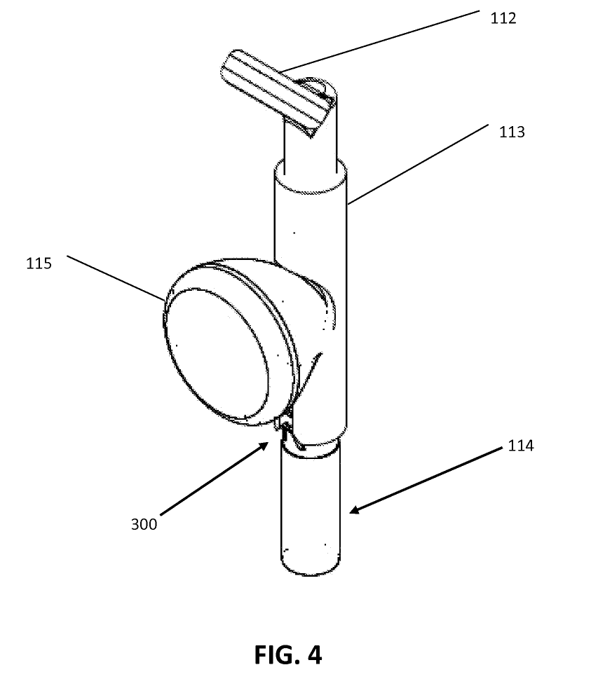

FIG. 4 shows an angled embodiment of the device. In this embodiment, the anchor 112 is operationally attached, screwed into, and angled to the cylindrical sleeve 113 at 45 degrees. The cylindrical sleeve 113 is operationally attached to the end of a headset 114 with an earbud 115. The cylindrical sleeve 113 contains a notch 300 which enables the cylindrical sleeve 113 to slide further down the end of the headset 114, creating more friction and a better connection between the cylindrical sleeve 113 and the end of the headset 114.

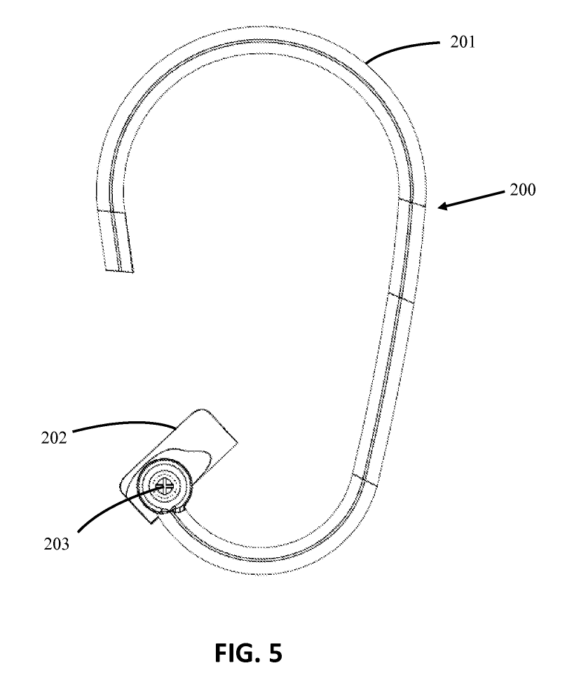

FIG. 5 shows a back view of an alternate embodiment of the device with an optional earhook. The device elements are identified as in FIG. 2.

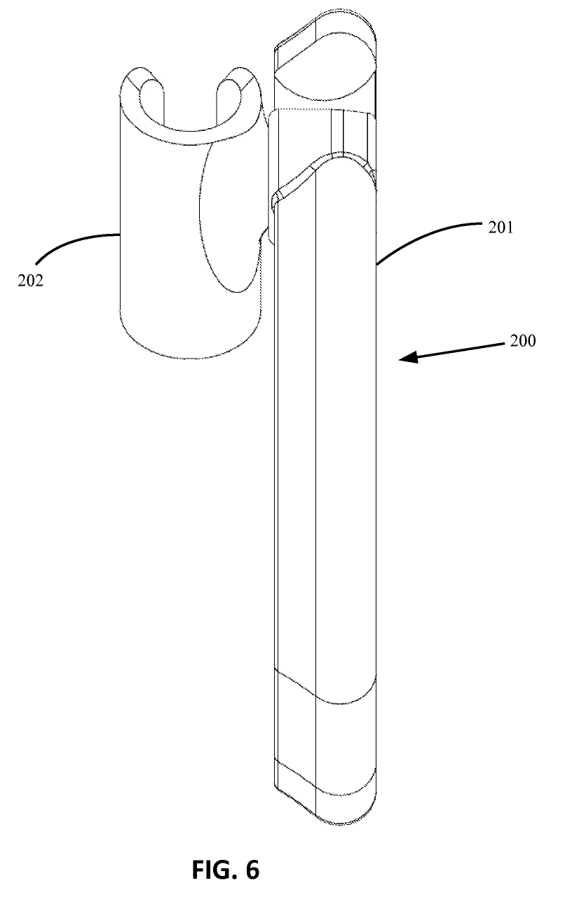

FIG. 6 shows a bottom view of an alternate embodiment of the device with an optional earhook. The device elements are identified as in FIG. 2.

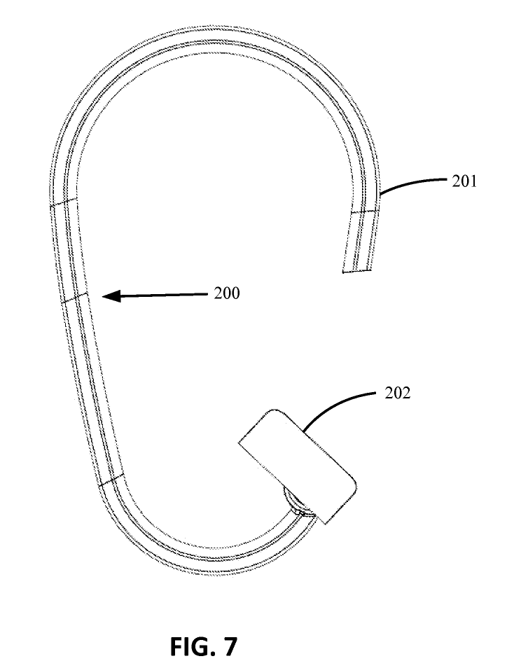

FIG. 7 shows a front view of an alternate embodiment of the device with an optional earhook. The device elements are identified as in FIG. 2.

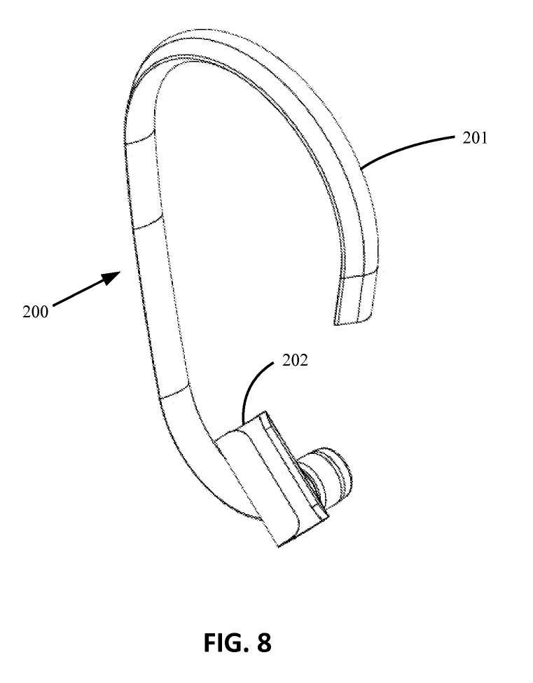

FIG. 8 shows an isometric view of an alternate embodiment of the device with an optional earhook. The device elements are identified as in FIG. 2.

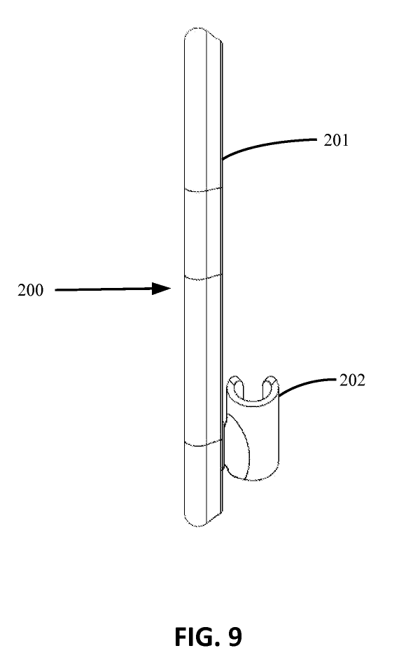

FIG. 9 shows a left view of an alternate embodiment of the device with an optional earhook. The device elements are identified as in FIG. 2.

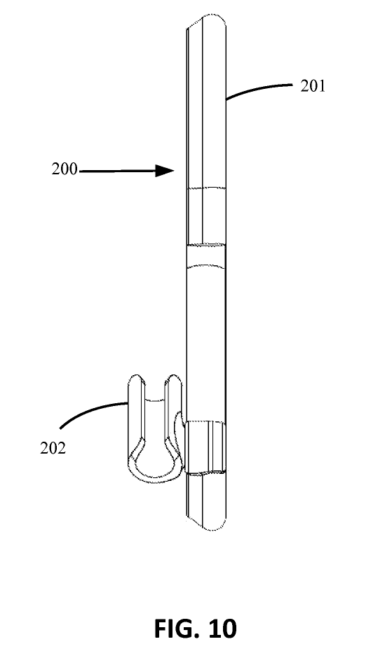

FIG. 10 shows a right view of an alternate embodiment of the device with an optional earhook. The device elements are identified as in FIG. 2.

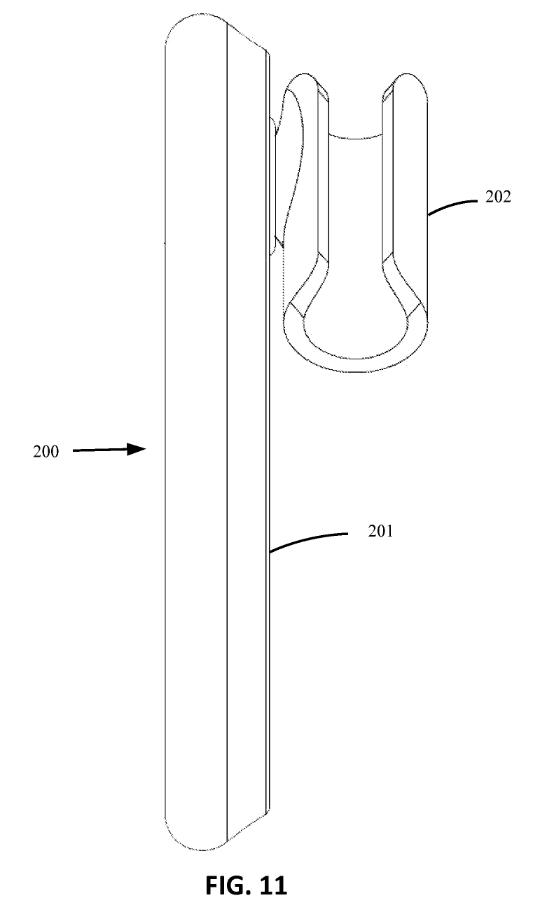

FIG. 11 shows a top view of an alternate embodiment of the device with an optional earhook. The device elements are identified as in FIG. 2.

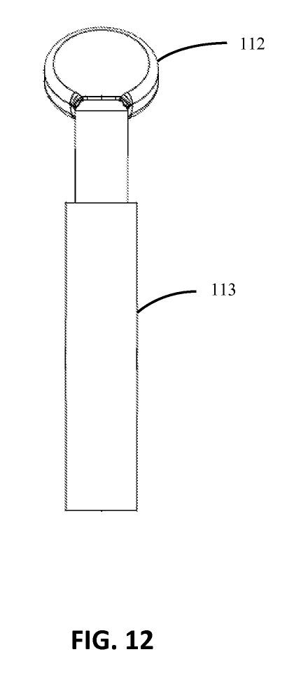

FIG. 12 shows a back view of an angled embodiment of the device. The device elements are identified as in FIG. 4.

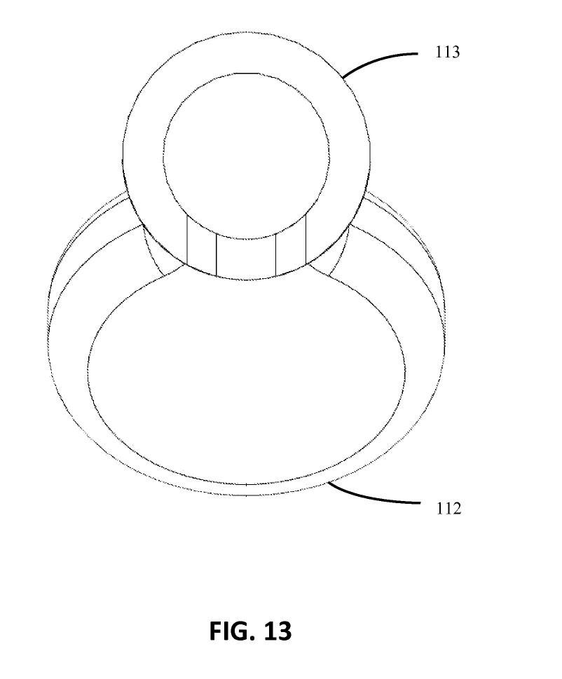

FIG. 13 shows a bottom view of an angled embodiment of the device. The device elements are identified as in FIG. 4.

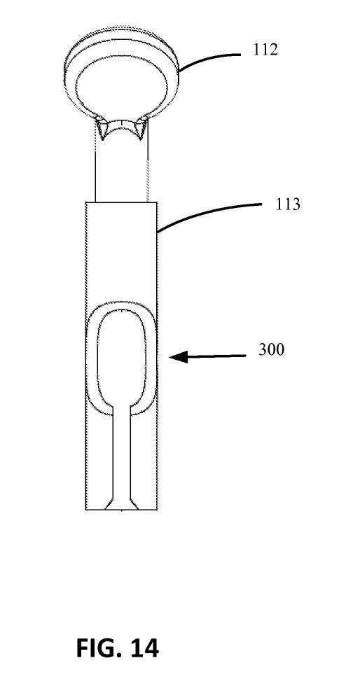

FIG. 14 shows a front view of an angled embodiment of the device. The device elements are identified as in FIG. 4.

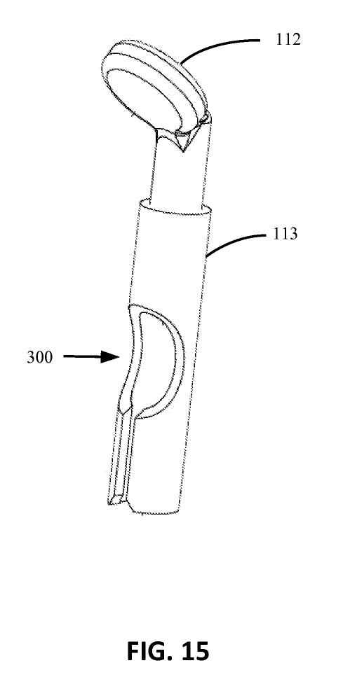

FIG. 15 shows an isometric view of an angled embodiment of the device. The device elements are identified as in FIG. 4.

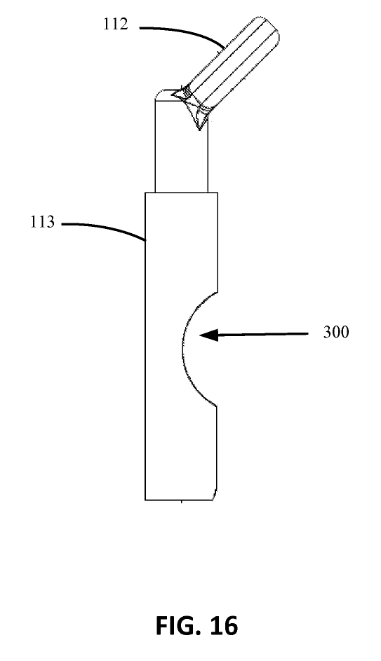

FIG. 16 shows a left view of an angled embodiment of the device. The device elements are identified as in FIG. 4.

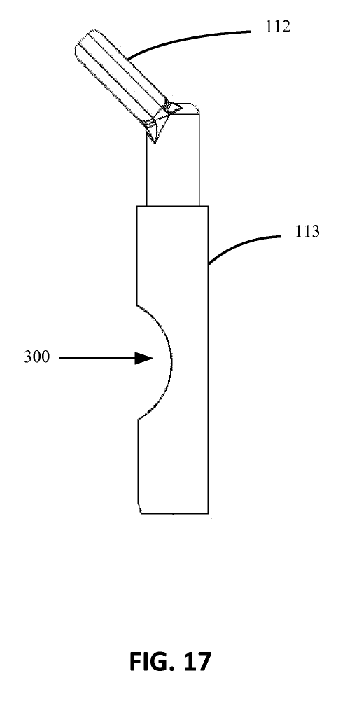

FIG. 17 shows a right view of an angled embodiment of the device. The device elements are identified as in FIG. 4.

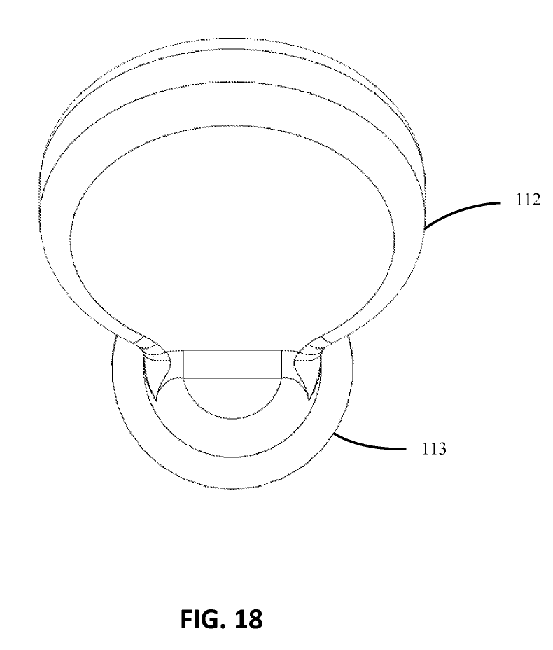

FIG. 18 shows a top view of an angled embodiment of the device. The device elements are identified as in FIG. 4.

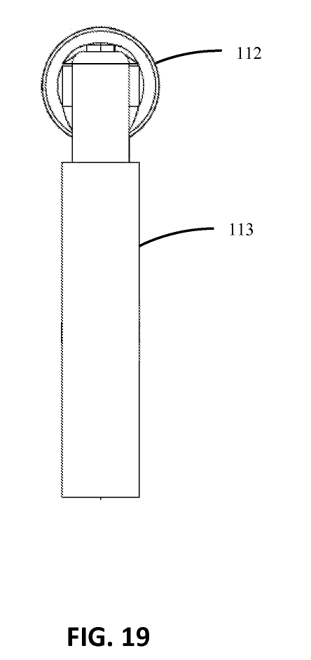

FIG. 19 shows a back view of a perpendicular embodiment of the device. The device elements are identified as in FIG. 3.

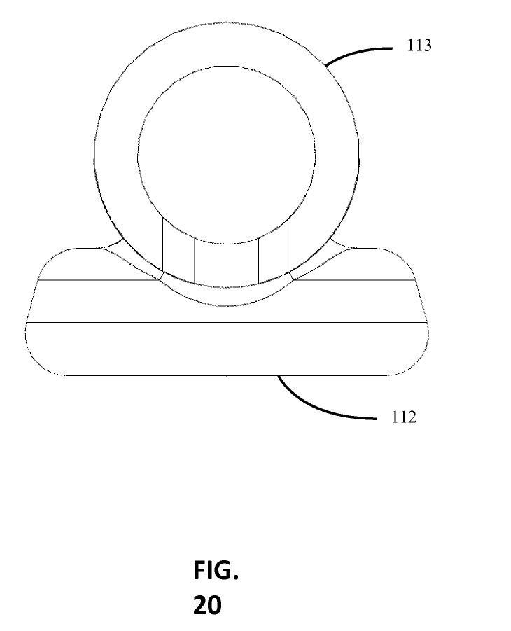

FIG. 20 shows a bottom view of a perpendicular embodiment of the device. The device elements are identified as in FIG. 3.

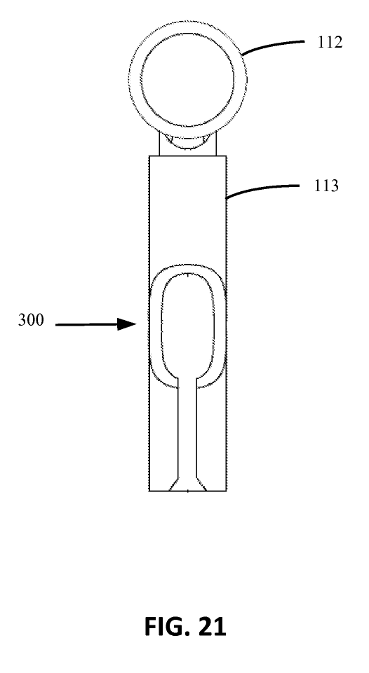

FIG. 21 shows a front view of a perpendicular embodiment of the device. The device elements are identified as in FIG. 3.

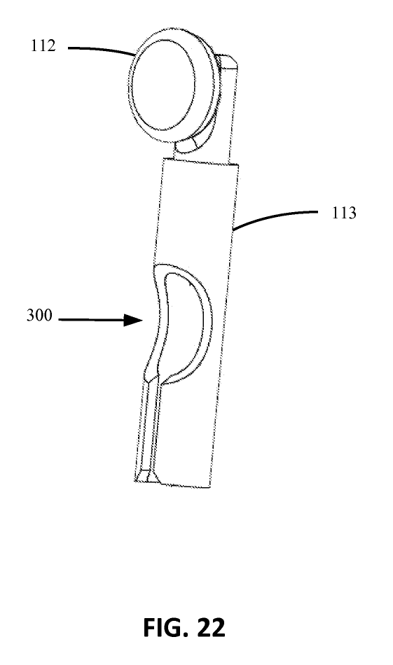

FIG. 22 shows an isometric view of a perpendicular embodiment of the device. The device elements are identified as in FIG. 3.

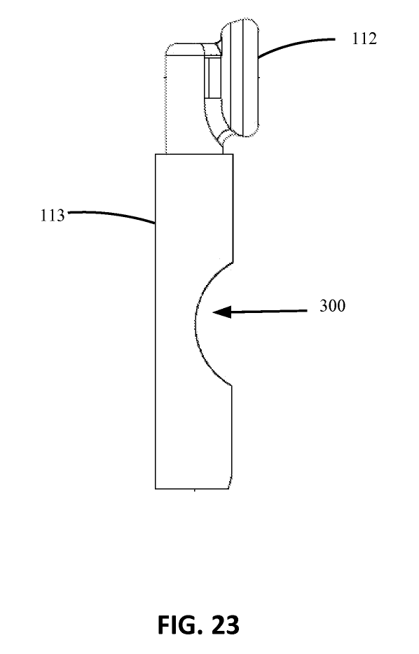

FIG. 23 shows a left view of a perpendicular embodiment of the device. The device elements are identified as in FIG. 3.

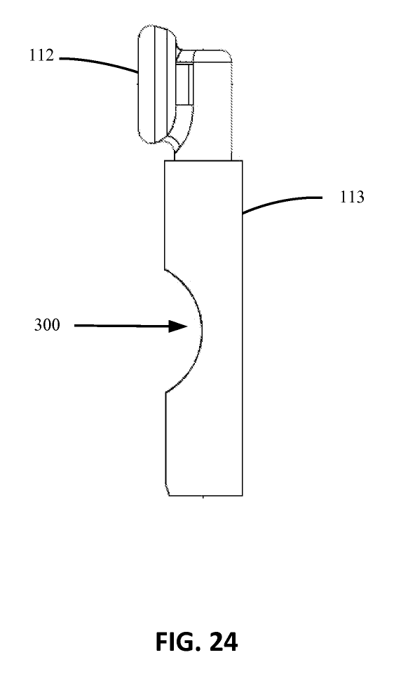

FIG. 24 shows a right view of a perpendicular embodiment of the device. The device elements are identified as in FIG. 3.

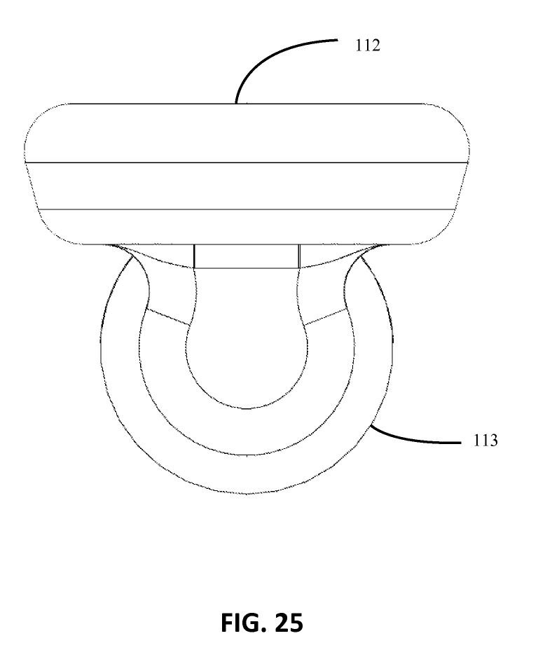

FIG. 25 shows a top view of a perpendicular embodiment of the device. The device elements are identified as in FIG. 3.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

I claim:

1. A device for enabling the optimal positioning of an earbud headset with both an earbud and a microphone on a wearer, the device comprising:
an anchor for positioning onto an ear of the wearer; and
a cylindrical sleeve which is operatively connected to the anchor and able to attach to the end of the earbud headset.

2. The device of claim 1, wherein the anchor is perpendicular to the cylindrical sleeve.

3. The device of claim 1, wherein the anchor is angled to the cylindrical sleeve.

4. A device for enabling the optimal positioning of an earbud headset with both an earbud and a microphone on a wearer, the device comprising:
an earhook for positioning around a human ear; and
a sleeve which is pivotally attached to the earhook and designed to hold the end of the earbud headset.
